(19) United States
(12) Patent Application Publication
(10) Pub. No.: US 2021/0345043 A1
(43) Pub. Date: Nov. 4, 2021

(54) SYSTEMS AND METHODS FOR EXTERNAL ENVIRONMENT SENSING AND RENDERING

(71) Applicant: Harman International Industries, Incorporated, Stamford, CT (US)

(72) Inventors: Christopher Michael Trestain, Livonia, MI (US); Maxwell Willis, Detroit, MI (US); Riley Winton, Opelika, AL (US)

(21) Appl. No.: 17/243,280

(22) Filed: Apr. 28, 2021

Related U.S. Application Data
(60) Provisional application No. 63/019,103, filed on May 1, 2020.

(51) Int. Cl. H04R 3/02; H04R 3/00

(52) U.S. Cl. CPC H04R 3/02; H04R 2499/13; H04R 3/005

(57) ABSTRACT

Systems and methods for generating sounds in a vehicle are presented. In one example, a sound or sounds generated external to a vehicle may facilitate generation of sounds within the vehicle. Sounds generated within the vehicle may be generated in a way to indicate a direction of the source of sounds generated external to the vehicle.

### CROSS REFERENCE TO RELATED APPLICATIONS

The present application claims priority to U.S. Provisional Application No. 63/019,103 entitled “SYSTEMS AND METHODS FOR EXTERNAL ENVIRONMENT SENSING AND RENDERING”, and filed on May 1, 2020. The entire contents of the above-identified application are hereby incorporated by reference for all purposes.

### BACKGROUND

The disclosure relates to vehicle systems responding sounds external to a vehicle.

### SUMMARY

A vehicle that is traveling on a road may encounter sounds that may be generated from sources external to the vehicle. For example, a large truck such as a tractor-trailer, garbage truck, gravel hauler, or the like may generate audible sounds near the vehicle when passing in front of, to the side of, or behind the vehicle. Further, emergency vehicles may pass the vehicle from time to time with their sirens operating in an activated state. However, these external sounds may not always be as noticeable as may be desired to a human driver of the vehicle due to vehicle sound proofing within the vehicle. Consequently, the human driver's situational awareness may not be as keen as may be desired.

The inventors have recognized the previously mentioned issues and have developed systems and methods to at least partially address the above issues. In particular, the inventors have developed a method for generating sounds in a vehicle, comprising: generating sounds within an interior of the vehicle via one or more speakers according to an angle between the vehicle and a source of a sound external to the vehicle.

By generating sounds within a vehicle according to an angle between the vehicle and the source of the sound external to the vehicle, speakers of the vehicle may notify a vehicle driver of a direction to a source of a sound external to the vehicle. For example, if an emergency vehicle is approaching the vehicle from a front and right side of the vehicle, speakers in the front and right side interior of the vehicle may produce a sound that notifies vehicle occupants of the direction of the emergency vehicle. For example, the sound external to the vehicle may be mapped to a virtual point in space, and the notifying sound may be reproduced inside the vehicle based on the virtual point in space, for example to sound as if it is coming from that virtual point. In addition, the sound produced within the vehicle may indicate the expected source of the sound external to the vehicle. In this way, vehicle occupants may be notified of a direction of an approaching sound source as well as an expected source of the sound.

The present description may provide several advantages. Specifically, the approach may improve situational awareness for passengers within a vehicle. In addition, the approach may direct a vehicle occupant's attention to a location outside the vehicle so that vehicle occupants may identify the source of the sound sooner. Further, the approach may include applications where a vehicle's navigation system offers alternative travel routes according to external vehicle noises so that a vehicle may reach its destination sooner.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example partial view of a vehicle cabin in accordance with one or more embodiments of the present disclosure;

FIG. 2 shows an example in-vehicle computing system in accordance with one or more embodiments of the present disclosure;

FIG. 3 shows an example sound processing system in a vehicle in accordance with one or more embodiments of the present disclosure;

FIGS. 4A-4C show schematic depictions of speakers that are activated in response to angle and distance of a sound source that is external to a vehicle; and

FIGS. 5-7 show flow charts of an example method for generating sound within a vehicle via an audio or infotainment system.

### DETAILED DESCRIPTION

The present disclosure relates to generating sounds within a vehicle passenger cabin according to sounds that are external to the vehicle. The sounds that are generated within the vehicle may be generated in a way that indicates the direction of the sound source that is external to the vehicle, the type of sound source, and the distance to the sound source. For example, a volume or sound output power level (e.g., decibels (dB)) within the vehicle may be adjusted based on the distance to the sound source that is external to the vehicle. In addition, the external sound source angle and distance relative to the vehicle may be passed to a navigation system that may alter a travel route based on the external sound source information.

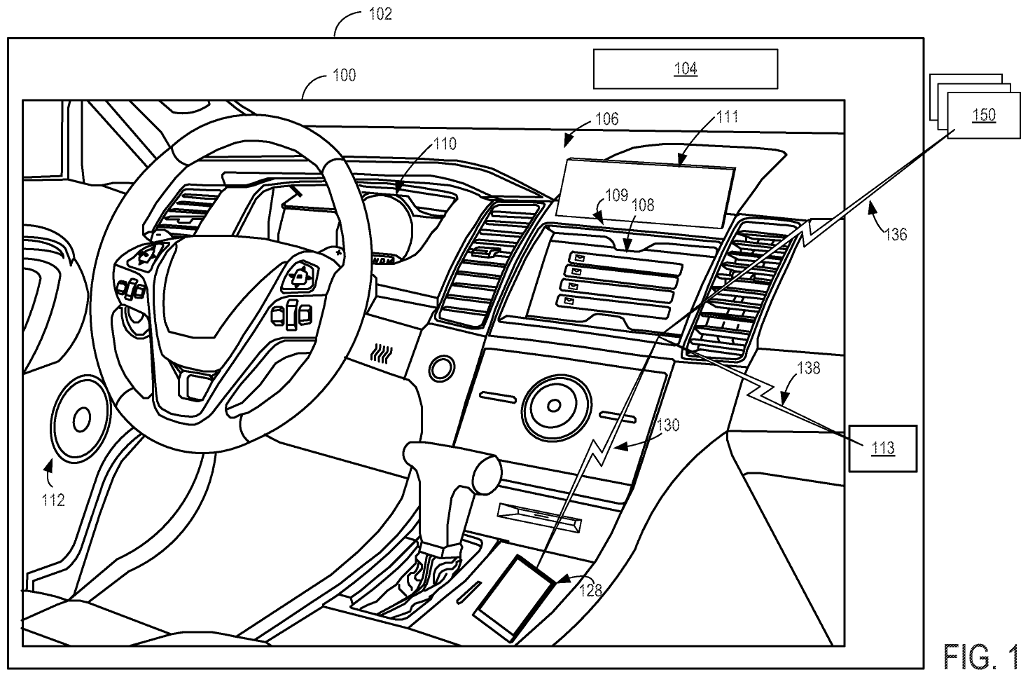

As shown in FIGS. 1-3, a system according to the present disclosure may be part of a vehicle, and methods according to the present disclosure may be carried out via an in-vehicle computing system.

FIG. 1 shows an example partial view of one type of environment for an audio customization system: an interior of a cabin 100 of a vehicle 102, in which a driver and/or one or more passengers may be seated. Vehicle 102 of FIG. 1 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a human driver (also referred to as the user) of vehicle 102. For example, instrument panel 106 may include a touch screen 108 of an in-vehicle computing system 109 (e.g., an infotainment system), an audio system control panel, and an instrument cluster 110. Touch screen 108 may receive user input to the in-vehicle computing system 109 for controlling audio output, visual display output, user preferences, control parameter selection, etc. While the example system shown in FIG. 1 includes audio system controls that may be performed via a user interface of in-vehicle computing system 109, such as touch screen 108 without a separate audio system control panel, in other embodiments, the vehicle may include an audio system control panel, which may include controls for a conventional vehicle audio system such as a radio, compact disc player, MP3 player, etc. The audio system controls may include features for controlling one or more aspects of audio output via speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system 109 may adjust a radio station selection, a playlist selection, a source of audio input (e.g., from radio or CD or MP3), etc., based on user input received directly via touch screen 108, or based on data regarding the user (such as a physical state and/or environment of the user) received via external devices 150 and/or mobile device 128.

In addition, the in-vehicle computing system 109 may adjust audio output volume or power output level, which speakers are activated, and signals for generating sounds at speakers in response to output from sound processor for external sounds 113. The audio system of the vehicle may include an amplifier (not shown) coupled to plurality of loudspeakers (not shown). Sound processor for external sounds 113 may be connected to the in-vehicle computing system via communication link 138 which may be wired or wireless, as discussed with reference to communication link 130, and configured to provide two-way communication between the sound processor for external sounds 113 and the in-vehicle computing system.

In some embodiments, one or more hardware elements of in-vehicle computing system 109, such as touch screen 108, a display screen 111, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of the in-vehicle computing system 109 may be modular and may be installed in multiple locations of the vehicle.

The cabin 100 may include one or more sensors for monitoring the vehicle, the user, and/or the environment. For example, the cabin 100 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin 100, etc. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, etc. Information regarding ambient conditions of the vehicle, vehicle status, or vehicle driver may also be received from sensors external to/separate from the vehicle (that is, not part of the vehicle system), such as sensors coupled to external devices 150 and/or mobile device 128.

Cabin 100 may also include one or more user objects, such as mobile device 128, that are stored in the vehicle before, during, and/or after travelling. The mobile device 128 may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct, Near-Field Communication [NFC], cellular connectivity, etc.) and configured to provide two-way communication between the mobile device and the in-vehicle computing system. The mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 130 may provide sensor and/or control signals from various vehicle systems (such as vehicle audio system, climate control system, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, GPS system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding contextual data, user behavior/preferences, operating rules, etc. and may transmit such information from the external devices 150 to in-vehicle computing system 109 and touch screen 108.

In-vehicle computing system 109 may analyze the input received from external devices 150, mobile device 128, sound processor for external sounds 113, and/or other input sources and select settings for various in-vehicle systems (such as climate control system or audio system), provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150.

In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

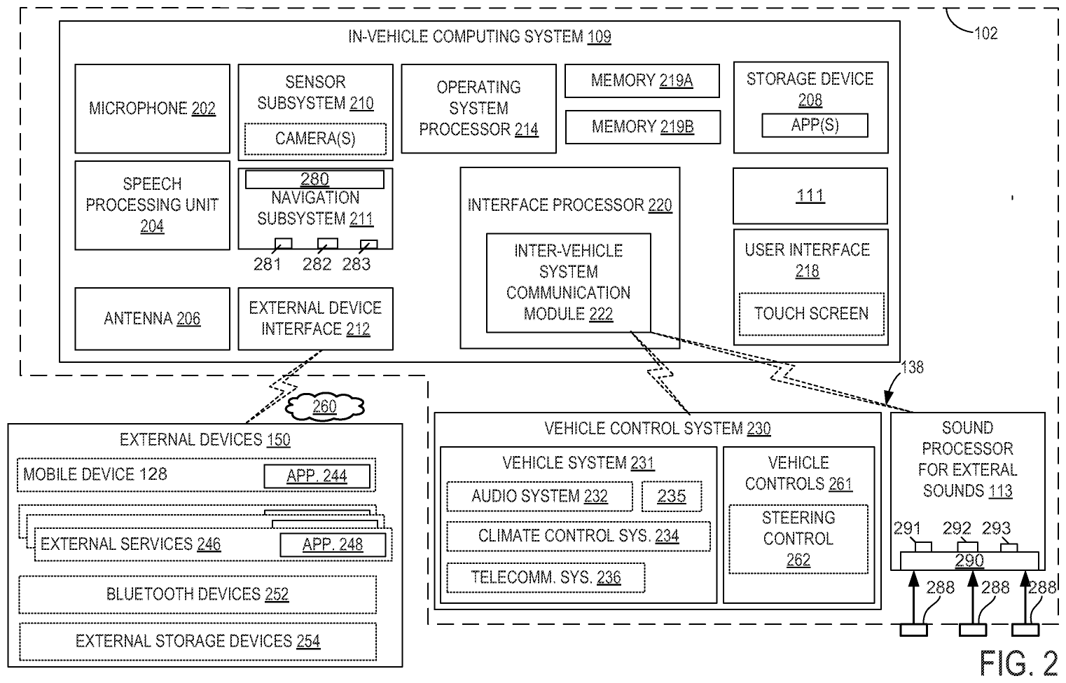

FIG. 2 shows a block diagram of an in-vehicle computing system 109 configured and/or integrated inside vehicle 102. In-vehicle computing system 109 may perform one or more of the methods described herein in some embodiments. In some examples, the in-vehicle computing system 109 may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 102 in order to enhance an in-vehicle experience for a driver and/or a passenger.

In-vehicle computing system 109 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 and sound processor for external sounds 113 via an inter-vehicle system communication module 222.

Inter-vehicle system communication module 222 may output data to other vehicle systems 231 and vehicle control elements 261, while also receiving data input from other vehicle components and systems 231, 261, e.g. by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine CAN bus through which engine related information may be communicated, a climate control CAN bus through which climate control related information may be communicated, and a multimedia data network through which multimedia data is communicated between multimedia components in the vehicle). For example, the in-vehicle computing system 109 may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 109 to store data such as instructions executable by processors 214 and 220 in non-volatile form. The storage device 208 may store application data, including prerecorded sounds, to enable the in-vehicle computing system 109 to run an application for connecting to a cloud-based server and/or collecting information for transmission to the cloud-based server. The application may retrieve information gathered by vehicle systems/sensors, input devices (e.g., user interface 218), data stored in volatile 219A or non-volatile storage device (e.g., memory) 219B, devices in communication with the in-vehicle computing system (e.g., a mobile device connected via a Bluetooth link), etc. In-vehicle computing system 109 may further include a volatile memory 219A. Volatile memory 219A may be random access memory (RAM). Non-transitory storage devices, such as non-volatile storage device 208 and/or non-volatile memory 219B, may store instructions and/or code that, when executed by a processor (e.g., operating system processor 214 and/or interface processor 220), controls the in-vehicle computing system 109 to perform one or more of the actions described in the disclosure.

A microphone 202 may be included in the in-vehicle computing system 109 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 109 may also be able to receive voice commands and sample ambient vehicle noise using a microphone included in an audio system 232 of the vehicle.

One or more additional sensors may be included in a sensor subsystem 210 of the in-vehicle computing system 109. For example, the sensor subsystem 210 may include a camera, such as a rear view camera for assisting a user in parking the vehicle and/or a cabin camera for identifying a user (e.g., using facial recognition and/or user gestures). Sensor subsystem 210 of in-vehicle computing system 109 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230.

A navigation subsystem 211 of in-vehicle computing system 109 may generate and/or receive navigation information such as location information (e.g., via a GPS sensor and/or other sensors from sensor subsystem 210), route guidance, traffic information, point-of-interest (POI) identification, and/or provide other navigational services for the driver. Navigation sub-system 211 may include inputs/outputs 280, including analog to digital converters, digital inputs, digital outputs, network outputs, radio frequency transmitting devices, etc. The sound processor for external sounds 113 may also include a central processing unit 281, volatile memory 282, and non-volatile (e.g., non-transient memory) 283.

External device interface 212 of in-vehicle computing system 109 may be coupleable to and/or communicate with one or more external devices 150 located external to vehicle 102. While the external devices are illustrated as being located external to vehicle 102, it is to be understood that they may be temporarily housed in vehicle 102, such as when the user is operating the external devices while operating vehicle 102. In other words, the external devices 150 are not integral to vehicle 102. The external devices 150 may include a mobile device 128 (e.g., connected via a Bluetooth, NFC, WIFI direct, or other wireless connection) or an alternate Bluetooth-enabled device 252. Mobile device 128 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. External devices 150 may communicate with in-vehicle computing system 109 either wirelessly or via connectors without departing from the scope of this disclosure. For example, external devices 150 may communicate with in-vehicle computing system 109 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the driver. For example, the external device interface 212 may enable phone calls to be established and/or text messages (e.g., SMS, MMS, etc.) to be sent (e.g., via a cellular communications network) to a mobile device associated with a contact of the driver. The external device interface 212 may additionally or alternatively provide a wireless communication interface to enable the in-vehicle computing system to synchronize data with one or more devices in the vehicle (e.g., the driver's mobile device) via WIFI direct.

One or more applications 244 may be operable on mobile device 128. As an example, mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 244 to external device interface 212 over network 260. In addition, specific user data requests may be received at mobile device 128 from in-vehicle computing system 109 via the external device interface 212. The specific data requests may include requests for determining where the user is geographically located, an ambient noise level and/or music genre at the user's location, an ambient weather condition (temperature, humidity, etc.) at the user's location, etc. Mobile device application 244 may send control instructions to components (e.g., microphone, amplifier etc.) or other applications (e.g., navigational applications) of mobile device 128 to enable the requested data to be collected on the mobile device or requested adjustment made to the components. Mobile device application 244 may then relay the collected information back to in-vehicle computing system 109.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, etc.), data from an internet query (e.g., weather data, POI data), etc. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers 235. Vehicle audio system 232 may be passive or active such as by including a power amplifier. In some examples, in-vehicle computing system 109 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 102. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers 235 of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 109, such as via communication module 222. The control elements of the vehicle control system may be physically and permanently positioned on and/or in the vehicle for receiving user input. In addition to receiving control instructions from in-vehicle computing system 109, vehicle control system 230 may also receive input from one or more external devices 150 operated by the user, such as from mobile device 128. This allows aspects of vehicle systems 231 and vehicle controls 261 to be controlled based on user input received from the external devices 150.

In-vehicle computing system 109 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via FR such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 150 (such as to mobile device 128) via external device interface 212.

One or more elements of the in-vehicle computing system 109 may be controlled by a user via user interface 218. User interface 218 may include a graphical user interface presented on a touch screen, such as touch screen 108 of FIG. 1, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 109 and mobile device 128 via user interface 218. In addition to receiving a user's vehicle setting preferences on user interface 218, vehicle settings selected by in-vehicle control system may be displayed to a user on user interface 218. Notifications and other messages (e.g., received messages), as well as navigational assistance, may be displayed to the user on a display of the user interface. User preferences/information and/or responses to presented messages may be performed via user input to the user interface.

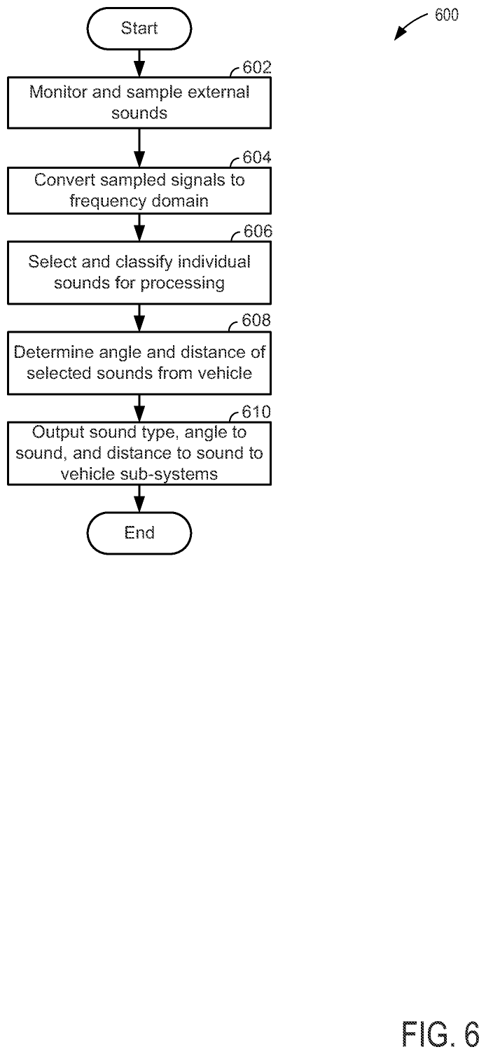

Sound processor for external sounds 113 may be electrically coupled to a plurality of microphones 288 that are external to vehicle 102 (e.g., external microphones). Sound processor for external sounds 113 may receive signals output from each of external microphones 288 and convert the signals into an angle value, a distance value, and a type identifier for sound sources that are external to vehicle 102. Sound processor for external sounds 113 may output angle data, distance data, and sound source type data to in-vehicle computing system 109 via communication link 138. However, in other examples, the tasks and functions that may be performed by sound processor for external sounds 113 may be integrated into in-vehicle computing system 109. In addition, external microphones 288 may be in direct electric communication with in-vehicle computing system 109 in such examples. The description of the method of FIG. 6 provides additional details as to the tasks and functions that may be performed via the sound processor for external sounds 113.

Sound processor for external sounds 113 may include inputs/outputs 290, including analog to digital converters, digital inputs, digital outputs, network outputs, radio frequency transmitting devices, etc. The sound processor for external sounds 113 may also include a central processing unit 291, volatile memory 292, and non-volatile (e.g., non-transient memory) 293.

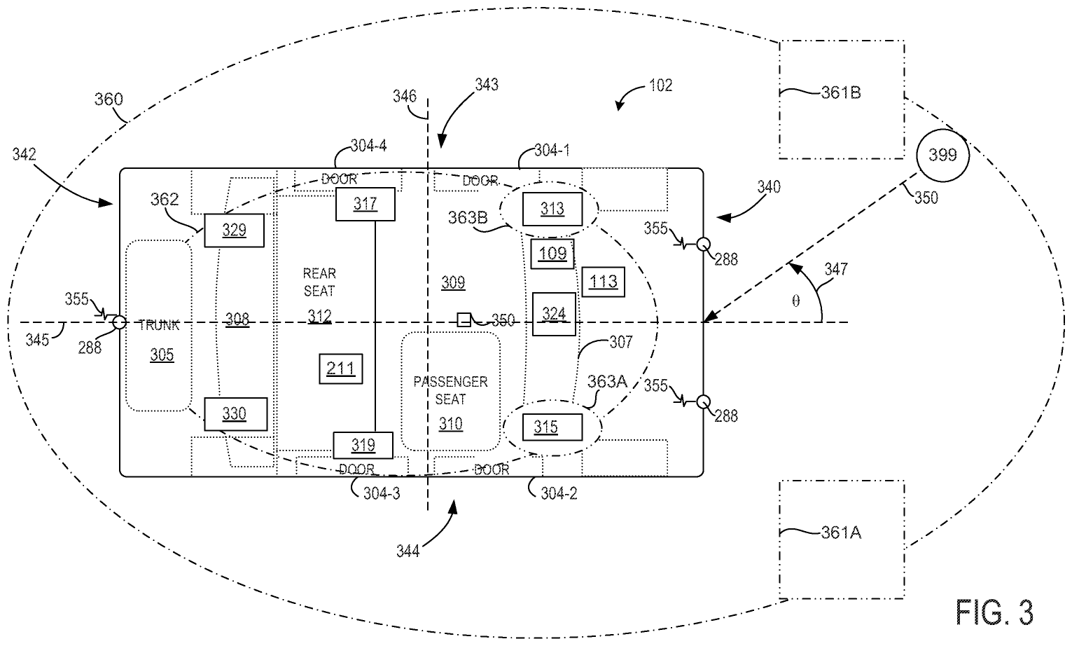

FIG. 3 is a block diagram of a vehicle 102 that may include in-vehicle computing system 109, audio or sound processing system 232, and sound processor for external sounds 113. The vehicle 102 has a front side 340, a rear side 342, left side 343, and right side 344. Vehicle 102 also includes doors 304, a driver seat 309, a passenger seat 310, and a rear seat 312. While a four-door vehicle is shown including doors 304-1, 304-2, 304-3, and 304-4, the processors and systems 109, 232, and 113 may be used in vehicles having more or fewer doors. The vehicle 102 may be an automobile, truck, boat, or the like. Although only one rear seat is shown, larger vehicles may have multiple rows of rear seats. Smaller vehicles may have only one or more seats. While a particular example configuration is shown, other configurations may be used including those with fewer or additional components.

The audio system 232 (which may include an amplifier and/or other audio processing device for receiving, processing, and/or outputting audio to one or more speakers of the vehicle) may improve the spatial characteristics of surround sound systems. The audio system 232 supports the use of a variety of audio components such as radios, COs, DVDs, their derivatives, and the like. The audio system 232 may use 2-channel source material such as direct left and right, 5.1 channel, 6.2 channel, 7 channel, 12 channel and/or any other source materials from a matrix decoder digitally encoded/decoded discrete source material, and the like. The audio system 232 utilizes a channel that is only for TI/HWL sounds and is separate from a channel/s for remaining sounds, including one or more of remaining warning, media, navigational, and telephone/telematics sounds.

The amplitude and phase characteristics of the source material and the reproduction of specific sound field characteristics in the listening environment both play a key role in the successful reproduction of a surround sound field. For example, sounds may be spatially mapped to the audio system 232 so that sounds are perceived to originate from a distinct spatial location that is related to, but a modification of, the detected true source location of the sound.

The audio system 232 may improve the reproduction of a surround sound field by controlling the sound delay time, surround upmixer parameters (e.g., wrap, reverb room size, reverb time, reverb gain, etc.), amplitude, phase, and mixing ratio between discrete and passive decoder surround signals and/or the direct two-channel output signals, in at least one example. The amplitude, phase, and mixing ratios may be controlled between the discrete and passive decoder output signals. The spatial sound field reproduction may be improved for all seating locations by re-orientation of the direct, passive, and active mixing and steering parameters, especially in a vehicle environment.

The mixing and steering ratios as well as spectral characteristics may be adaptively modified as a function of the noise and other environmental factors. In a vehicle, information from the data bus, microphones, and other transduction devices may be used to control the mixing and steering parameters.

The vehicle 102 has a front center speaker (CTR speaker) 324, a front left speaker (FL speaker) 313, a front right speaker (FR speaker) 315, and at least one pair of surround speakers.

The surround speakers may be a left side speaker (LS speaker) 317 and a right side speaker (RS speaker) 319, a left rear speaker (LR speaker) 329 and a right rear speaker (RR speaker) 330, or a combination of speaker sets. Other speaker sets may be used. While not shown, one or more dedicated subwoofers or other drivers may be present. Possible subwoofer mounting locations include the trunk 305, below a seat, or the rear shelf 308. The vehicle 102 may also have one or more microphones 350 mounted in the interior.

Each CTR speaker, FL speaker, FR speaker, LS speaker, RS speaker, LR speaker, and RR speaker may include one or more transducers of a predetermined range of frequency response such as a tweeter, a mid-range, or a woofer. The tweeter, mid-range, or woofer may be mounted adjacent to each other in essentially the same location or in different locations. For example, the FL speaker 313 may be a tweeter located in door 304-1 or elsewhere at a height roughly equivalent to a side mirror or higher. The FR speaker 315 may have a similar arrangement to FL speaker 313 on the right side of the vehicle (e.g., in door 304-2).

The LR speaker 329 and the RR speaker 330 may each be a woofer mounted in the rear shelf 308. The CTR speaker 324 may be mounted in the front dashboard 307, in the roof, on or near the rear-view mirror, or elsewhere in the vehicle 102. In other examples, other configurations of loudspeakers with other frequency response ranges are possible. In some embodiments, additional speakers may be added to an upper pillar in the vehicle to enhance the height of the sound image. For example, an upper pillar may include a vertical or near-vertical support of a car's window area. In some examples, the additional speakers may be added to an upper region of an “A” pillar toward a front of the vehicle.

Vehicle 102 includes a longitudinal axis 345 and a lateral axis 346. Locations of sound sources (e.g., sirens, engines, alarms, etc.) may be referenced to longitudinal axis 345, lateral axis 346, or other positions of vehicle 102. In this example, a distance to external noise source 399 (e.g., vehicle, engine, siren, alarm, horn, etc.) is shown via vector 350. An angle θ between longitudinal axis (e.g., a position of the vehicle) and the external noise source 399 is shown via angle θ and as indicated by leader 347. The angle θ and the distance from vehicle 102 to external noise source 399 may be determined via external sound processor 113 processing signals 355 representing sounds received via external microphones 288 positioned near the front side 340 and rear side 342 of vehicle 102. For example, based on the angle θ and the distance from vehicle 102 to external noise source 399 determined via external sound processor 113, the external sound 399 may be mapped to a distinct location in virtual space that is directly related to, e.g., a specific proportion of, the determined actual angle and distance. As an example, the controller may map the external sound 399 to a virtual spatial map describing the space surrounding the vehicle, such as a virtual sound source region 360.

The external sound source 399 may be within virtual sound source region 360, and the position of external sound source 399 within virtual sound source region 360 may be determined or based on its angle θ and distance 350 relative to vehicle 102. In this example, the virtual sound source region 360 surrounds vehicle 102, but in other examples, the virtual sound source region may extend only in front of vehicle 102. The in-vehicle computing system 109 may command the audio system 232 to play sound through one or more speakers located within virtual speaker region 362 according to the position of external sound source 399 within virtual sound source region 360. In one example, individual external sound source positions within virtual sound source region 360 may be mapped to individual locations of speakers in virtual speaker region 362. Virtual speaker region 362 includes speakers 329, 330, 317, 319, 313, 324, and 315. Consequently, a position of external sound source 399 may be continuously tracked in real-time and the position of external sound source 399 may be applied to generate sounds that are associated with a type of the external sound source 399 via one or more speakers that are mapped to the position of external sound source 399. For example, speaker 329 may generate sounds that are associated with a type of external sound source 399 when the external sound source is to the right rear of side of vehicle 102. Likewise, speaker 330 may generate sounds that are associated with a type of external sound source 399 when the external sound source is to the left rear of side of vehicle 102.

In another example, rather than mapping spatial locations to discrete speakers, the external sound source 399 may be continuously mapped to the virtual speaker regions 362, and each speaker may be adjusted in order to reproduce the perceived spatial location of the sound. Specifically, there may be a 1:1 mapping between the virtual sound source region 360 and the virtual speaker region 362, so that a location of the external sound source 399 may be reproduced by the audio system 232. As an example, the in-vehicle computing system 109 may determine the location of external sound source 399 in the virtual sound source region 360. Further, the in-vehicle computing system 109 may determine the corresponding location in to the virtual speaker region 362, so that the spatial location of the external sound source 399 may be reproduced in the virtual speaker region 362. For example, the in-vehicle computing system may adjust audio gains, panning settings, and other audio settings for each speaker of the virtual speaker region 362 based on the spatial location of the external sound source 399. As one example, in order to map the spatial location of external sound source 399, based on the angle θ and the distance 350 from the vehicle 102, the plurality of speakers may generate sounds that are associated with a type of external sound source 399.

In one example, the vehicle navigation system may include two virtual direction regions 361A and 361B that are located in front of vehicle 102. The vehicle navigation system may request that a driver drive to one of the two virtual direction regions 361A (e.g., right turn) and 361B (e.g., left turn) so that the vehicle may reach an intended destination. Thus, the vehicle navigation system may request that the vehicle driver to turn right (e.g., to 361A) or left (e.g., to 361B). The navigation system 211 may command the audio system 232 to play sound through left front speaker 313 or right front speaker 315 within virtual speaker regions 363A and 363B according to the requested virtual direction regions 361A and 361B. The right virtual direction region 361A may be mapped to front right speaker 315 via virtual speaker region 363B so that verbal driving instructions may be played through the front right speaker 315 when the navigation system requests the vehicle driver to turn right. Similarly, the left virtual direction region 361B may be mapped to front left speaker 313 via virtual speaker region 363A so that verbal driving instructions may be played through the front left speaker 313 when the navigation system requests the vehicle driver to turn left. Thus, the system of FIGS. 1-3 provides for a sound system of a vehicle, comprising: one or more speakers; one or more microphones external to the vehicle; and a controller electrically coupled to the one or more speakers including executable instructions stored in non-transitory memory that cause the controller to generate sounds within an interior of the vehicle in response to a distance and an angle generated via output of the one or more microphones. The system further comprises a sound processor, the sound processor electrically coupled to the one or more microphones, the sound processor outputting the distance and angle to the controller. The system includes where the distance is a distance from the vehicle to a sound source external to the vehicle, and where the angle is an angle from a position of the vehicle to the sound source external to the vehicle. The system further comprises a navigation system, the navigation system configured to display a travel route of the vehicle and adjust the travel route of the vehicle in response to at least one of the angle and the distance. The system further comprises additional executable instructions to generate the sounds within the interior of the vehicle in response to type assigned to a sound generated external to the vehicle. For example, the system may determine a 1:1 mapping between an external sound source region and a virtual speaker region, and generate the sounds within the interior of the vehicle based on the mapping. The system includes where the type assigned to the sound generated external to the vehicle includes at least an emergency vehicle sound.

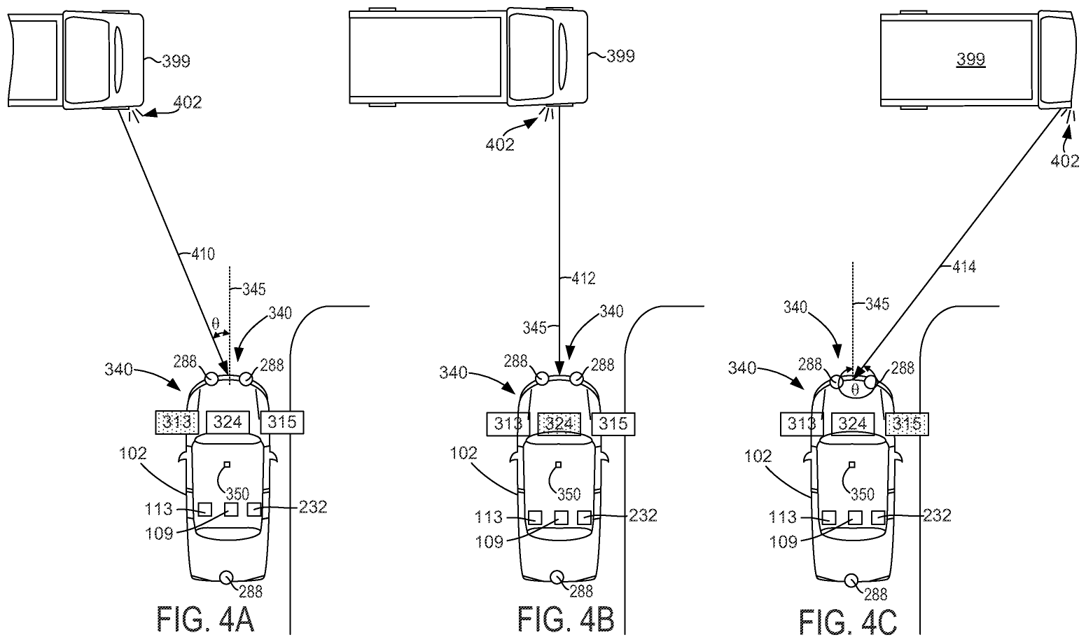

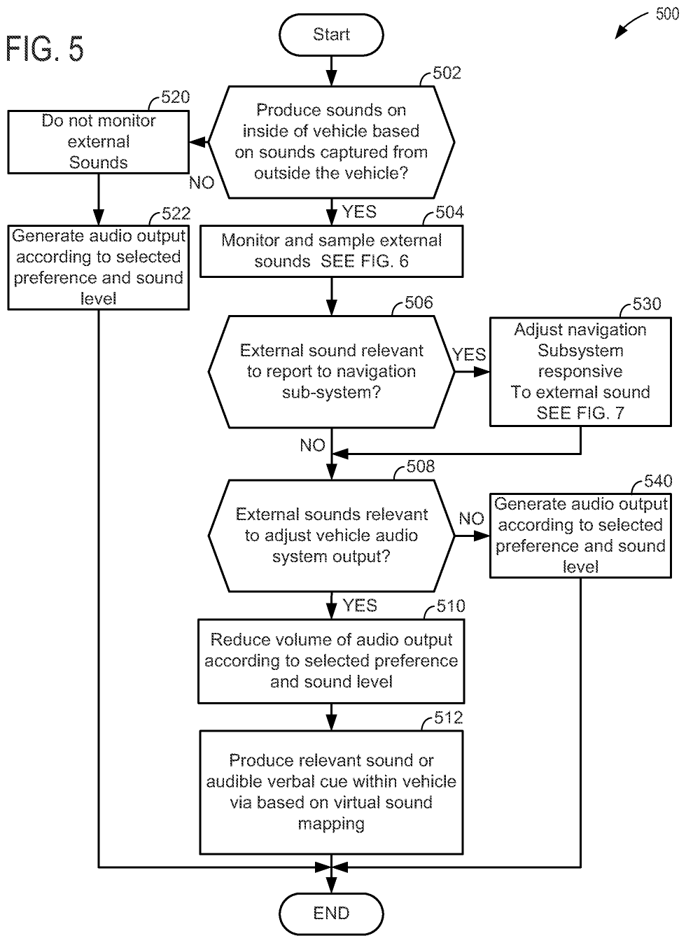

Turning now to FIG. 4A, a schematic example that illustrates a portion of the method of FIGS. 5-7 is shown. In this example, external noise source 399 is a truck that is positioned in front of and to the left of vehicle 102. Truck 399 may emit engine noise and tire noise that may be detected via microphones 288 positioned at a front side 340 of vehicle 102.

In this example, since noise source 399 is a vehicle 102 that approaches from the front left hand side of vehicle 102, the audio system 232 is commanded to output a sound or verbal cue that is mapped to the front left hand side of the virtual speaker region 362. Specifically, the sounds or verbal cues associated with the truck may be panned so that they are perceived as originating from the front left hand side of the vehicle. As an example, the sounds or verbal cues may be panned between the plurality of speakers in the vehicle based on a known relationship between audio panning and perceived spatial location, such as a surround sound technique known in the art (e.g., such as 5.1 surround sound, 7.1 surround sound, ambisonic surround sound, and the like). As one non-limiting example, the front left speaker 313 (shown shaded) may have the highest audio gain of the plurality of speakers in the vehicle (e.g., the sound or verbal cue may be panned to the front left), while the sounds or verbal cues may be quieter in the front center speaker 324 and the front right speaker 315. In some examples, additional speakers of the audio system 232 may also be used to output the sounds or verbal cues.

In addition, the audio system 232 may be commanded to reduce a volume of any sounds it is playing that are not associated with the noise source 399 approaching vehicle 102. Further, audio system 232 may be commanded to adjust the volume of sounds that are being played that are associated with or based on the noise source 399 approaching. For example, as the noise source 399 gets closer to vehicle 102, a volume of sounds being played by audio system 232 that are associated with or based on approaching noise source 399 may be increased. In some examples, the relationship between distance of the noise source 399 and the volume of sounds being played by audio system 232 may be a linear relationship, while in other examples, the relationship may be a non-linear relationship. Also, the volume of sounds being played by audio system 232 that are associated with or based on approaching noise source 399 may be adjusted in response to the amount of noise from noise source 399 that is detected within the passenger compartment via interior microphone 350. For example, if noise from noise source 399 is relatively loud as the noise source 399 gets closer to vehicle 102, a volume of sounds being played by audio system 232 that are associated with or based on approaching noise source 399 may be decreased. However, if noise from noise source 399 is relatively quiet as the noise source 399 gets closer to vehicle 102, a volume of sounds being played by audio system 232 that are associated with or based on approaching noise source 399 may be increased.

The control of speakers (e.g., such as 313, 324, and 315) and audio system 232 may be controlled via the sound processor for external sounds 113 processing signals generated via microphones 288 to determine angle θ relative to the vehicle's longitudinal axis 345, the distance from vehicle 102 to the noise source 399 as indicated by vector 410, and the type of noise source. The angle θ, distance, and type of noise source may be supplied from the sound processor for external sounds 113 to the in-vehicle computing system 109. The in-vehicle computing system 109 may command audio system 232 to play a predetermined sound via a particular speaker or group of speakers according to the angle θ, distance, and type of noise source.

In this way, sounds played in a vehicle may direct a human driver's attention to a noise source that is external to a vehicle so that the human driver's situational awareness may be improved. In addition, sounds output from the vehicle's interior speakers may be adjusted to compensate for the distance that the noise source is from the vehicle so that sound in the passenger cabin may not become bothersome.

Referring now to FIG. 4B, a second schematic example that illustrates a portion of the method of FIGS. 5-7 is shown. In this example, external noise source 399 is a truck that is positioned directly in front of vehicle 102. Truck 399 may emit engine noise and tire noise that may be detected via microphones 288 positioned at a front side 340 of vehicle 102.

In this example, the audio system is again commanded to output a sound or verbal cue to a speaker that is closest to the noise source 399. Since noise source 399 is directly in front of vehicle 102, the audio system 232 is commanded to play sounds or verbal cues that are mapped to the front center of the virtual speaker region 362. Specifically, the sounds or verbal cues associated with the truck may be panned so that they are perceived as originating from the front center of the vehicle. For example, the sounds or verbal cues may be panned between the plurality of speakers in the vehicle based on the known relationship between audio panning and perceived spatial location. As one non-limiting example, the front center speaker 324 (shown shaded) may have the highest audio gain of the plurality of speakers in the vehicle (e.g., the sounds or verbal cues may be panned to the front center), while the sounds or verbal cues may be quieter in the front left speaker 313 and the front right speaker 315. The audio system may also respond to the angle and distance of noise source 399 as discussed with regard to FIG. 4A.

Referring now to FIG. 4C, a third schematic example that illustrates a portion of the method of FIGS. 5-7 is shown. In this example, external noise source 399 is a truck that is positioned to the right front of vehicle 102. Truck 399 may emit engine noise and tire noise that may be detected via microphones 288 positioned at a front side 340 of vehicle 102.

In this example, the audio system is commanded to output a sound or verbal cue that are mapped to the front right of the virtual speaker region 362. Specifically, the sounds or verbal cues associated with the truck may be panned so that they are perceived as originating from the front center of the vehicle. For example, the sounds or verbal cues may be panned between the plurality of speakers in the vehicle based on the known relationship between audio panning and perceived spatial location. As one non-limiting example, the front right speaker 315 (shown shaded) may have the highest audio gain of the plurality of speakers in the vehicle (e.g., the sound or verbal cues may be panned to the front right), while the sounds or verbal cues may be quieter in the front left speaker 313 and the front center speaker 324. The audio system may also respond to the angle and distance of noise source 399 as discussed with regard to FIG. 4A.

Thus, from FIGS. 4A-4C it may be observed that as a position of an external noise source changes relative to vehicle 102, speakers playing sounds or verbal cues that are related to noise source 399 may be adjusted so as to progressively indicate the position of noise source 399. Further, the volume output from vehicle speakers may be adjusted responsive to the type of noise source and distance to the noise source 399.

FIGS. 5-7 shows flow charts for example methods 500-700 for adjusting audio output (e.g., in a vehicle). Methods 500-700 may be performed by a computing system 109 and/or combination of computing systems and audio systems, which may include one or more computing systems integrated in a vehicle. Sound processor for external sounds 113 may also be included in the system that performs the methods of FIGS. 5-7. For example, methods 500-700 may be performed by executing instructions stored in non-transitory memory of an in-vehicle computing system 109 alone or in combination with one or more other vehicle systems (e.g., audio controllers, sound processors for external sounds, CAN buses, engine controllers, etc.) that include executable instructions stored in non-transitory memory. The computing system 109 in conjunction with other systems describe herein may perform methods 500-700 including adjusting actuators (e.g., speakers) in the real world and perform operations internally that ultimately are a basis for adjusting actuators in the real world. One or more steps included in methods 500-700 may optionally be performed.

At 502, the method 500 judges if the vehicle systems are to produce sounds on the inside of the vehicle based on sounds detected on the outside of the vehicle. Method 500 may receive input from a human machine interface (e.g., touch screen 108) that indicates whether or not vehicle occupants wish to be notified of sounds external to the vehicle. In other examples, method 500 may judge if vehicle operating conditions indicate a desire or usefulness for notifying vehicle occupants of sounds that are external to the vehicle. For example, if the vehicle is traveling in an urban area the answer may be yes. However, if the vehicle is traveling off road, the answer may be no. If method 500 judges that the answer is yes, method 500 proceeds to 504. Otherwise, the answer is no and method 500 proceeds to 520.

At 520, method 500 does not monitor external vehicle sounds and the sound processor for external sounds may be turned off or set to a low power consumption state. Method 500 proceeds to 522.

At 522, method 500 generates audio output within the passenger cabin via speakers based on selections provided by vehicle occupants or automated selection. For example, if vehicle passengers select a specific music genre or artist, the audio system plays a selection from the genre or artist at a volume level that is selected by the vehicle occupants or an automated control. Further, speakers that are activated and outputting sounds and speakers that are not outputting sounds may be based on user selected sound fields and modes (e.g., stadium, surround sound, stereo, mono, etc.). Method 500 may also provide visual output according to selections that are provided by vehicle occupants or automated selection. For example, method 500 may display a music video via the touch screen according to the selected artist or music genre. Method 500 proceeds to exit.

At 504, method 500 monitors and samples sounds that are external to the vehicle as described in further detail in the description of FIG. 6. Method 500 proceeds to 506.

At 506, method 500 judges if external sounds are relevant to report to the vehicle navigation sub-system. Method 500 may judge that external sounds are relevant to report to the vehicle navigation sub-system if the vehicle navigation sub-system is activated and displaying a requested travel route for the vehicle. In addition, method 500 may also consider other factors and vehicle operating conditions to determine if external sounds are relevant to report to the vehicle navigation sub-system. For example, if the vehicle is traveling city streets where the vehicle may easily change directions, method 500 may judge that external sounds are relevant to report to the navigation sub-system. However, if the vehicle is traveling on a road that has limited exits (e.g., a highway), then method 500 may not judge that the external sounds are relevant to report to the navigation sub-system. In still other examples, method 500 may judge if an external sound is relevant to report to the vehicle navigation sub-system based on the type of external sound. For example, method 500 may deem that sounds from emergency vehicles are relevant to notify the vehicle navigation sub-system while sounds from tractor-trailers are not relevant to notify the vehicle navigation sub-system. In some examples, the vehicle navigation sub-system may be notified of noise sources that are determined to be within a predetermined distance of the vehicle. If method 500 judges that noise or sounds external to the vehicle are judged to be relevant to report to the navigation sub-system, then the answer is yes and method 500 proceeds to 530. Otherwise, the answer is no and method 500 proceeds to 508.

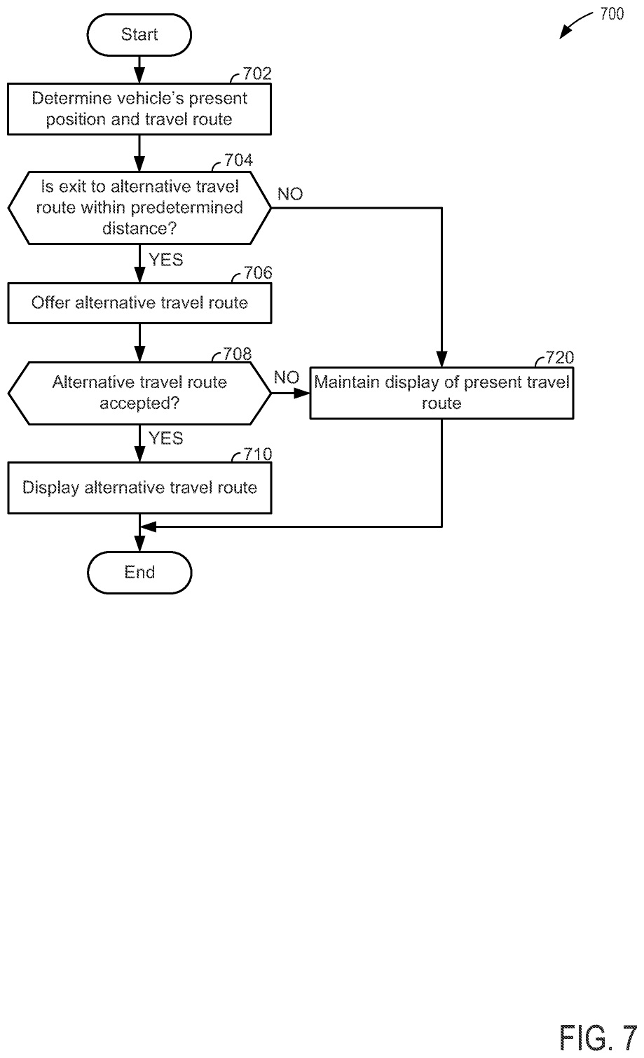

At 530, method 500 adjusts the navigation sub-system output responsive to the monitored external sounds as discussed in the description of FIG. 7. Method 500 proceeds to 508.

At 508, method 500 judges if external sounds are relevant to adjust output of the vehicle's audio system. Method 500 may judge that external sounds are relevant to adjust the audio system if the external sounds are within predetermined frequency ranges and power levels. In addition, method 500 may judge that external sounds determined to originate from emergency vehicles are relevant to adjust the vehicle's audio system, but tractor-trailer sounds are not relevant to adjust the vehicle's audio system based on user selections for external sound notification. In still other examples, method 500 may judge that sounds determined to originate from emergency vehicles and tractor-trailer sounds are relevant to adjust the vehicle's audio system. If method 500 judges that noise or sounds external to the vehicle are judged to be relevant to report to the vehicle's audio system, then the answer is yes and method 500 proceeds to 510. Otherwise, the answer is no and method 500 proceeds to 540.

At 540, method 500 continues to generate audio system output via speakers according to selected preferences and sound level. In particular, method 500 generates audio output within the passenger cabin based on selections provided by vehicle occupants or automated selection to the audio system or in-vehicle computing system. Method 500 proceeds to exit.

At 512, method 500 generates relevant sounds and/or audible verbal cues within the passenger compartment via speakers in response to the angle between a position of the vehicle and the location of the sound source (e.g., e in FIG. 4A), the distance from the vehicle to the external noise source (e.g., vector 410 in FIG. 4A), and the indicated type of external sound as determined at 504. For example, method 500 may generate the relevant sounds and/or audible verbal cues, and may reproduce them via the vehicle audio system based on a 1:1 virtual mapping of the external sound to vehicle audio system. As an example, based on the location of the sound source, and the distance from the vehicle to the external sound source, method 500 may map the external sound source to a point in a virtual sound space.

In one example, method 500 may generate siren sounds within the passenger cabin from prerecorded siren sounds when a siren sound is detected external to the vehicle. Method 500 may also generate truck sounds within the passenger cabin from prerecorded truck sounds with a truck sound is detected external to the vehicle. Likewise, other sounds detected external to the vehicle may be the basis for generating similar sounds in the passenger cabin.

Method 500 may adjust reverb of the generated sounds within the passenger cabin as a function of a distance between the present vehicle and the source of the external sound so that vehicle occupants may perceive that the source of the external sound is approaching the present vehicle or heading away from the present vehicle. Method 500 may adjust reverb gain and time as a function of the distance between the present vehicle and the source of the external sound. Additionally, in some examples, method 500 may output predetermined verbal cues in response to a determined type of sound. For example, method 500 may cause the audio system to generate a verbal warning such as “Caution emergency vehicle approaching” or “Caution tractor-trailer approaching.” Method 500 may also indicate a distance and from which direction the source of the external noise is approaching. For example, method 500 may generate a verbal warning such as “Caution emergency vehicle approaching from the left at 50 meters” or “Caution emergency vehicle approaching from rear at 100 meters.”

Method 500 may also adjust and control which speakers output the sounds that are based on the detected external sounds. In particular, method 500 may adjust and control which speakers output the sounds in order to simulate the spatial location of the external sounds. For example, as described above, method 500 may map the external sound source to the point in the virtual sound space of the vehicle, and may adjust and control each speaker so that the relevant sounds and/or audible verbal cues issue from the same point in the virtual sound space of the vehicle. For example, as shown in FIGS. 4A-4C and as described in their accompanying description, method 500 may generate sounds in the passenger cabin via speakers that are closest to the origin or source of the external sound. Specifically, method 500 may pan the relevant sounds and/or verbal audio cues to the correct point in the virtual sound space of the vehicle. In addition, method 500 may adjust a volume of the sound output from the speakers according to the distance between the vehicle and the origin or source of the external sound. For example, if a source of an external sound is approaching the vehicle, the volume of sounds generated in the vehicle based on the external sounds may increases. If the source of the external sound is moving away from the vehicle, the volume of sounds generated in the vehicle based on the external sounds may decrease. Further, the actual total number of speakers that are outputting the sounds generated in the vehicle based on the external sounds may be adjusted in response to the angle between the vehicle and the external sound source and the distance between the vehicle and the external sound source. For example, if a noise generating vehicle is a relatively longer distance from the present vehicle a single speaker may output a noise based on the noise generating vehicle noise output. However, if the noise generating vehicle is relatively close to the present vehicle two or more speakers may output sound based on the noise generating vehicle noise output. Further, if a noise generating vehicle is approaching the present vehicle from a left hand side at a first angle, one speaker may output sound based on the first angle. However, if the noise generating vehicle is approaching the present vehicle from the left hand side at a second angle, two speakers may output sound based on the second angle.

Method 500 may also adjust volume of the speakers outputting the sound in the vehicle cabin that is based on the external sound as a function of the sound power level of the external sound that is detected within the passenger cabin via a microphone. For example, if an external sound source is approaching the present vehicle and a microphone in the vehicle detects a high power level or sound level of sounds from the external sound source, then method 500 may produce sounds in the passenger cabin that are related to or based on the external sound at a lower volume or power level. However, if an external sound source is approaching the present vehicle and a microphone in the vehicle detects a lower power level or sound level of sounds from the external sound source, then method 500 may produce sounds in the passenger cabin that are related to or based on the external sound at a higher volume or power level.

Method 500 may also assign different levels of priority to different sound types as determined at 504. For example, a higher priority may be assigned to emergency sound types than to tractor-trailer sound types. Method 500 may generate a sound that may be related to a higher priority sound type while not generating a sound that may be related to a lower priority sound type so that driver confusion may be avoided.

Method 500 may generate sounds that are related to or associated with detected external sounds until a vehicle occupant acknowledges that notice to the external sound source has been received. Further, method 500 may repeatedly generate sounds until a vehicle occupant acknowledges that notice to the external sound source has been received. Method 500 proceeds to exit after producing sounds in the passenger cabin that are relevant to external sounds.

Referring now to FIG. 6, a method for monitoring sounds external to a vehicle is shown. Method 600 may be included as part of the method of FIG. 5. Further, the method of FIG. 6 may be included in one or more of the systems (e.g., a sound processor for external sounds) described herein as executable instructions stored in non-transitory memory.

At 602, method 600 monitors outputs of external microphones that are mounted to the vehicle (e.g., 288 of FIG. 2). In one example, the microphones output analog signals that are sampled via analog to digital converters of a sound processor for external sounds. The sampled signal data may be stored to controller volatile memory. In other examples, the microphones may output digital data that is input to the sound processor for external signals or the in-vehicle computing system. Method 600 proceeds to 604.

At 604, method 600 may convert data from the microphones that is in the time domain to frequency domain. For example, method 600 may apply a Fourier transform to determine frequencies and magnitude or power levels of signals at different frequencies. The frequencies and power levels may be stored to controller volatile memory for further processing. Method 600 proceeds to 606.

At 606, method selects and classifies individual sounds by type from the sampled microphone data. Since different sounds may occur at different frequencies, the frequencies in the microphone data may be indicative or a type of sound source generating the sound that was picked up by the external microphones. For example, emergency siren sounds may occur at higher frequencies while diesel engine sounds may occur at lower frequencies. Method 600 may compare frequencies detected from the microphone data with predetermined frequencies that are store in controller memory and associated with particular sound sources. If a frequency or frequency range determined from microphone data matches a frequency or frequency range type stored in controller memory, then it may be determined that the external sound is being generated via a known or predetermined sound generating source. For example, if frequencies of between 500 and 1500 Hz are detected with a predetermined amount of time sampled data (e.g., over 4 seconds), then the frequencies may be indicative of a sweeping siren. Conversely, frequency of sound from a diesel engine may be relatively constant over a predetermined time, so diesel engine sound may be classified in such a way. In this way, a particular sound may be assigned a type (e.g., emergency, tractor-trailer, children, backing up vehicle, etc.). Method 600 may store and identify more than one sound source at a time this way. Method 600 proceeds to 608.

At 608, method 600 determines an angle between the present vehicle and the source of the external sound. In one example, method 600 determines phase changes in sound frequencies between two or more microphones to determine the angle between the present vehicle and the source of the external sound. Further, method 600 may determine the distance between the present vehicle and the source of the external sound based on phase differences between sounds captured via the one or more external microphones. Method 600 proceeds to 610.

At 610, method 600 outputs the angle and distance between the present vehicle and a source of an external sound. Method 600 may also indicate the type of sound source (e.g., emergency vehicle, siren, horn, tractor-trailer, etc.) or sound source type that is associated with the source of the external sound. In some cases, method 600 may output angle, distance, and sound source type data for a plurality of sounds as determined from external microphone data to other systems and processors. Method 600 proceeds to exit.

Referring now to FIG. 7, a method for adjusting navigation system output according to external sounds is shown. Method 700 may be included as part of the method of FIG. 5. Further, the method of FIG. 7 may be included in one or more of the systems (e.g., a navigation sub-system) described herein as executable instructions stored in non-transitory memory.

At 702, method 700 may determine the present vehicle's present geographical position via a global positioning system and/or geographical maps stored in controller memory. In addition, method 700 determines a present travel route based on a requested destination that is input via a vehicle occupant or autonomous driver. The present travel route may be based on shortest distance, shortest travel time, or other requirements. The present travel route may be a travel route that is not based on sounds external to the present vehicle.

Method 700 may also request a vehicle's human driver to turn right via a verbal audible command output via front right speaker 315 when the travel route includes an upcoming right turn. Similarly, method 700 may also request a vehicle's human driver to turn left via a verbal audible command output via front left speaker 313 when the travel route includes an upcoming left turn. Thus, method 700 maps requests for upcoming right turns to front right speaker 315. Method 700 maps requests for upcoming left turns to front left speaker 313. Method 700 proceeds to 704.

At 704, method 700 judges if there is an exit on the present travel route that is within a predetermined distance of the vehicle (e.g., between the vehicle and the source of the external sound). If so, the answer is yes and method 700 proceeds to 706. Otherwise, the answer is no and method 700 proceeds to 720.

At 720, method 700 maintains the display of the present travel route on a display in the vehicle. Method 700 proceeds to exit.

At 706, method 700 determines an alternative travel route based on the angle to the external detected sound source and the requested destination. For example, if the present travel route is straight ahead of the vehicle, but the external sound is determined to be straight ahead of the vehicle, the alternative travel route may direct the vehicle driver to turn right, then turn left, then turn left, and then turn right again to direct the driver around the sound source. Method 700 proceeds to 708.

At 708, method 700 judges if the alternative travel route is accepted by a driver or vehicle occupant. If so, the answer is yes and method 700 proceeds to 710. Otherwise, the answer is no and method 700 proceeds to 720.

At 710, method 700 displays the alternative travel route via the in vehicle display. Method 700 proceeds to exit.

Thus, the method of FIGS. 5-7 provides for a method for generating sounds in a vehicle, comprising: generating sounds within an interior of the vehicle via one or more speakers according to an angle between a position of the vehicle and a source of a sound external to the vehicle. The method includes wherein generating sounds includes generating a sound indicative of the source of the sound external to the vehicle. The method includes wherein generating sounds includes generating a verbal sound that indicates the direction of the sound and a sound type associated with the source of the sound external to the vehicle. The method further comprises receiving the angle from a sound processor to an in vehicle computing system and generating the sounds via the in vehicle computing system. The method further comprises adjusting which of the one or more speakers outputs the generated sounds as the angle between the vehicle and the source of the sound external to the vehicle changes. The method includes where generating sounds includes applying reverb to a signal as a function of a distance between the vehicle and the source of the sound external to the vehicle. The method further comprises generating the sounds in response to one or more attributes of a sound generated via the source of the sound external to the vehicle. The method further comprises adjusting one or more attributes of other sounds generated via the one or more speakers. The method includes where the one or more attributes of the other sounds generated via the one or more speakers includes a volume of the other sounds generated via the one or more speakers.

The method of FIGS. 5-7 also provides for a method for generating sounds in a vehicle, comprising: adjusting a plurality of speakers to generate sounds within an interior of the vehicle according to an angle between a position of the vehicle and a source of a sound external to the vehicle. The method further comprises adjusting an attribute of the generated sounds in response to an attribute of the sound external to the vehicle that is sensed within the vehicle. The method includes where the attribute of the generated sounds is a first volume or sound power level, and where the attribute of the sound external to the vehicle is a second volume or power level. The method includes where adjusting which of the plurality of speakers generate sounds within the interior of the vehicle includes increasing an actual total number of speakers included in the plurality of speakers generating the sounds. The method further comprises adjusting the generated sounds within the vehicle in response to a type of source that generated the sound external to the vehicle. The method further comprising mapping a first requested turning direction generated via a navigation system to a first speaker, mapping a second requested turning direction generated via the navigation system to a second speaker, and mapping a notification of an external sound to a mapping that includes the first speaker, the second speaker, and a plurality of additional speakers.

The description of embodiments has been presented for purposes of illustration and description. Suitable modifications and variations to the embodiments may be performed in light of the above description or may be acquired from practicing the methods. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, etc. The described methods and associated actions may also be performed in various orders in addition to the order described in this application, in parallel, and/or simultaneously. Further, the described methods may be repeatedly performed. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. A method for generating sounds in a vehicle, comprising:
generating sounds within an interior of the vehicle via one or more speakers according to an angle between a position of the vehicle and a source of a sound external to the vehicle.

2. The method of claim 1, wherein generating sounds includes generating a sound indicative of the source of the sound external to the vehicle.

3. The method of claim 1, wherein generating sounds includes generating a verbal sound that indicates a direction of the sound and a sound type associated with the source of the sound external to the vehicle.

4. The method of claim 1, further comprising receiving the angle from a sound processor to an in vehicle computing system and generating the sounds via the in vehicle computing system.

5. The method of claim 1, further comprising adjusting which of the one or more speakers outputs the generated sounds as the angle between the vehicle and the source of the sound external to the vehicle changes.

6. The method of claim 1, where generating sounds includes applying reverb to a signal as a function of a distance between the vehicle and the source of the sound external to the vehicle.

7. The method of claim 1, further comprising generating the sounds in response to one or more attributes of a sound generated via the source of the sound external to the vehicle.

8. The method of claim 1, further comprising adjusting one or more attributes of other sounds generated via the one or more speakers.

9. The method of claim 8, where the one or more attributes of the other sounds generated via the one or more speakers includes a volume of the other sounds generated via the one or more speakers.

10. A sound system of a vehicle, comprising:
one or more speakers;
one or more microphones external to the vehicle; and
a controller electrically coupled to the one or more speakers including executable instructions stored in non-transitory memory that cause the controller to generate sounds within an interior of the vehicle in response to a distance and an angle generated via output of the one or more microphones.

11. The sound system of claim 10, further comprising a sound processor, the sound processor electrically coupled to the one or more microphones, the sound processor outputting the distance and angle to the controller.

12. The sound system of claim 11, where the distance is a distance from the vehicle to a sound source external to the vehicle, and where the angle is an angle from a position of the vehicle to the sound source external to the vehicle.

13. The sound system of claim 12, further comprising a navigation system, the navigation system configured to display a travel route of the vehicle and adjust the travel route of the vehicle in response to at least one of the angle and the distance.

14. The sound system of claim 12, further comprising additional executable instructions to generate the sounds within the interior of the vehicle in response to type assigned to a sound generated external to the vehicle.

15. The sound system of claim 14, where the type assigned to the sound generated external to the vehicle includes at least an emergency vehicle sound.

16. A method for generating sounds in a vehicle, comprising:
adjusting which of a plurality of speakers generate sounds within an interior of the vehicle according to an angle between a position of the vehicle and a source of a sound external to the vehicle.

17. The method of claim 16, further comprising adjusting an attribute of the generated sounds in response to an attribute of the sound external to the vehicle that is sensed within the vehicle.

18. The method of claim 17, where the attribute of the generated sounds is a first volume or power level, and where the attribute of the sound external to the vehicle is a second volume or power level.

19. The method of claim 16, where adjusting which of the plurality of speakers generate sounds within the interior of the vehicle includes increasing an actual total number of speakers included in the plurality of speakers generating the sounds.

20. The method of claim 16, further comprising mapping a first requested turning direction generated via a navigation system to a first speaker, mapping a second requested turning direction generated via the navigation system to a second speaker, and mapping a notification of an external sound to a mapping that includes the first speaker, the second speaker, and a plurality of additional speakers.
